(19) United States
(12) Patent Application Publication
(10) Pub. No.: US 2003/0175500 A1
(43) Pub. Date: Sep. 18, 2003

(54) Polymer coating for rubber articles

(76) Inventors: Apala Mukherjee, South Orange, NJ (US); Chaodong Xiao, East Hanover, NJ (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/378,026

(22) Filed: Feb. 28, 2003

Related U.S. Application Data
(60) Provisional application No. 60/365,659, filed on Mar. 18, 2002.

(51) Int. Cl. B32B 5/16

(52) U.S. Cl. 428/323

(57) ABSTRACT

The present invention is directed to the use of a polymer coating composition microbeads and a high Tg polymer with a Tg of greater than −10° C. for the inner coating on natural and synthetic rubber articles, particularly for latex gloves. The coating composition provides an inner surface coating that reduces friction between the latex and the hand to allow convenient donning. The coating composition is deliverable from an aqueous solution.

### CROSS REFERENCE TO RELATED APPLICATIONS

This application claims the benefit of United States Provisional Application No. 60/365,659 filed Mar. 18, 2002.

### FIELD OF THE INVENTION

The present invention relates to the use of a polymeric coating composition for rubber articles. In particular the polymeric coating composition is useful for the inside coating of latex gloves. The coating contains a high Tg polymer having dispersed microspheres.

### BACKGROUND OF THE INVENTION

As used herein, the terms latex glove or latex article refer to a glove or article made of natural or synthetic rubber. Conventional medical gloves made from natural or synthetic rubber are difficult to don without a lubricant. Generally, said gloves are manufactured with a powdered coating, such as corn starch, over the inner surface of the glove so that the gloves can be more easily put on. The powder coating is a known nuisance, as loose powder can become airborne. The powder tends to absorb proteins found in natural rubber latex and the powder is easily dislodged during donning and use, contaminating the surrounding environment and causing allergies and other negative effects. Further, the protein/powder complex serves as a food source for bacteria, allowing them to proliferate. Recently, there has been a growing demand for powder-free natural and synthetic rubber gloves, which do not use loose powder for donning and mold release.

Glove manufacturers have tried to find alternatives to using starch powder to coat gloves. Some latex glove manufacturers use a chlorination process to provide the slippage necessary to facilitate donning of the gloves. In this case, calcium carbonate is used as a mold release agent and washed away prior to chlorination. Although this reduces the tack and friction of the rubber, this chlorination process makes the rubber less pliant and reduces the shelf life of the glove.

Manufacturers have looked at polymer based coatings. To be an effective substitute for starch, the inner surface coating must not only reduce friction between the rubber and the hand to allow convenient donning, but also must allow the rubber to stretch without coating delamination, i.e. have a high coefficient of elongation combined with low tack and a low coefficient of friction. Further, the coating should be deliverable from an aqueous solution, which should be stable in extreme environmental conditions, and meet any relevant regulatory requirements.

Several types of coatings have been developed, primarily based on polyurethanes: U.S. Pat. No. 5,088,125 discloses gloves modified by an ionic polyurethane; U.S. Pat. No. 5,272,771 discloses gloves modified by an ionic polyurethane containing fully reacted isocyanate groups; and U.S. Pat. No. 5,534,350 discloses gloves in which the outer glove coating contains a polyurethane dispersion and the inside glove coating contains a polyurethane containing a silicone emulsion.

Other coatings which have been developed include emulsion copolymers, particularly core-shell, containing low surface energy monomers and hard monomers as disclosed in U.S. Pat. Nos. 5,691,069 and 5,700,585; or containing two monomers selected from styrene, methyl or butyl acrylates, methacrylic or acrylic acid and a silicone oligomer, with glass transition temperatures of less than 0° C. and from 0 to 100° C. respectively as disclosed in U.S. Pat. No. 5,712,346. These sequential emulsion polymerizations lead to substantially linear copolymers. Copending U.S. patent application Ser. No. 09/400,488 describes the use of star polymers as coatings for latex gloves.

Other coatings have been developed containing a slip conferring component: U.S. Pat. Nos. 4,070,713 and 4,143,109 disclose a medical glove with particulate matter securely embedded in, and randomly distributed throughout the inner layer; U.S. Pat. No. 5,395,666 discloses a flexible article coated with a binder and porous absorbent microparticles having average diameters of from 4 to about 20 microns and an oil adsorption greater than 180 g/100 g of powder.

Copending U.S. patent application Ser. No. 09/663,468 describes a polymer coating for rubber articles requiring a high Tg polymer, microspheres, and a separate dispersant. The dispersant could be a polymer.

Surprisingly, it has now been discovered that a formulation containing a high Tg polymer, and microspheres, without the need for an additional dispersant, provides blocking and an excellent slip conferring coating to latex gloves and other natural and synthetic rubber articles. The high Tg polymer acts as both a binder and as a dispersant, providing stabilization and uniform dispersion of particles. The polymer is used as the sole polymer in the coating, avoiding the use of a polymer blend that could require a compatibilizer such as a surfactant to create an intimate and stable blend, especially in an aqueous environment.

### SUMMARY OF THE INVENTION

The present invention is directed to the use of a polymer coating composition having microspheres, and a high Tg polymer as a continuous coating for rubber articles, particularly for the inner surface of latex gloves.

Microspheres are small beads having diameters below 60 microns. The microspheres decrease the area of contact with the rubber article, and thus reduce the friction.

The high Tg polymer is one having a Tg of from −10° C. to 120° C. The high Tg polymer acts as a friction-reducing agent and a binder, as well as a dispersant that serves to distribute the individual components within the coating composition.

Other embodiments of the invention include methods of making a glove in which a polymer coating composition having microspheres, and a high Tg polymer, is applied to the glove as the inner glove coating.

The coating is resistant to water and can be delivered from an aqueous solution.

### DETAILED DESCRIPTION OF THE INVENTION

The present invention is directed to the use of a polymer coating composition having microspheres, and a high Tg polymer, as a coating for rubber articles, particularly for the inner coating of latex gloves.

The microspheres are useful to reduce the friction between the coated rubber article, by decreasing the contact area with the coating. The microspheres have diameters below 60 microns, preferably from 5 to 40 microns, and most preferrably from 10 to 30 microns. The microspheres have a low oil adsorption of less than 150 g/100 g powder, preferably less than 100 g/100 g powder, and most preferably less than 80 g/100 g powder. The microsphere may be made of any material which is harder than the article being coated. Examples of microspheres useful in the present invention are those made of polyamides such as nylons, polymethylmethacrylate, polystyrene, polyethylene, polypropylene, polytetrafluoroethylene, polyesters, polyethers, polysulfones, polycarbonates, polyether ether ketones, and other thermoplastics and their copolymers, silica, and microcrystalline cellulose. Preferably the microspheres are present in the coating composition at from 0.01 to 1 percent by weight.

The high Tg polymer of the invention is a polymer or copolymer, which acts as a dispersant, a binder, and to reduce friction. A high Tg polymer in the context of the invention is one having a Tg from −10 to 120° C., preferably from 25 to 110° C. and most preferably from 40° C. to 70° C. Polymers useful in the present invention are those formed from ethylenically unsaturated monomers by means known in the art, or mixtures thereof. Particularly useful polymers include (meth)acrylic copolymers, vinyl acrylics, polyvinyl acetate, vinyl copolymers, ethylene-vinyl acetate copolymers, and polyurethanes. Optionally, a high Tg copolymer could also contain a low energy monomer, and adhesion promoter.

The high Tg polymer can be made by means known in the art. Preferably the polymer is formed by emulsion polymerization. It is preferably present in the coating composition at from 0.1 to 10 percent by weight, and preferably from 0.5 to 5 percent by weight.

In addition to the dispersant, microbeads and high Tg polymer, it can be advantageous to optionally add a rheology modifier to the coating composition. The rheology modifier is used to control the viscosity of the composition for ease of use in different manufacturing processes and equipment. It also aids in the suspension of microbeads and asists in pick-up of the coating formulation onto the surface of the rubber article. Rheology modifiers useful in the present invention include, but are not limited to cellulosics such as hyroxyethylcellulose, cationic hydroxyethylcellulose, such as Polyquaternium-4 and Polyquaternium-10, hydrophobically modified hydroxyethylcellulose, carboxymethylcellulose, methylcellulose, and hydroxypropylcellulose; dispersed or soluble starches or modified starches; and polysaccharide gums such as xanthan gum, guar gum, cationic guar gum such as Guar Hydroxypropyltrimonium Chloride, and locust bean gum. Other suitable rheology modifiers include but are not limited to alkali swellable emulsion polymers, which are typically made by emulsion copolymerization of (meth)acrylic acid with compatible ethylenically unsaturated monomers such as alkyl esters of (meth)acrylic acid, hydroxyalkyl esters of (meth)acrylic acid, alpha-methyl styrene, styrene, and derivatives thereof, vinyl acetate, crotonic acid, esters of crotonic acid, and acrylamide, and derivatives thereof; hydrophobically modified alkali swellable emulsion polymers, which are alkali swellable emulsion polymers into which hydrophobic groups have been introduced; certain amphiphilic polyurethanes; poly(acrylamide), copolymers of acrylamide with compatible ethylenically unsaturated monomers, poly(vinyl amides) such as poly(vinyl pyrrolidinone); and copolymers of vinyl amides such as vinyl pyrrolidinone with compatible ethylenically unsaturated monomers. The rheology modifier is typically added at from 0.01 to 1% by weight, and preferably from 0.05 to 0.15% by weight, based on the polymer coating composition.

The polymer coating composition may also contain other additives known in the art, such as adhesion promoters, surfactants, crosslinking agents, biocides, low surface energy compounds, and fillers.

The polymer coating composition of the present invention is made by combining each of the ingredients to form an aqueous dispersion.

The polymer coating composition may be used on the inside of an article, such as a glove, to form a continuous film that will provide slippage and promote donning. By continuous film, as used herein, is meant a single layer matrix that is non-intermittent and covers the surface of the article. Such a film may contain holes and cracks that are not visible without magnification.

The polymeric coating may be used to coat a variety of natural and synthetic rubber items, including gloves, prophylactics, catheters, balloons, tubing, and sheeting. A particularly suitable end use application is the coating of latex gloves, including surgeons' gloves, physicians' examining gloves, and workers' gloves, more particularly powder-free latex gloves. Such coating may be used on the inside of the glove to provide slippage and promote donning. They also impart ant-block properties.

When used to coat gloves, the polymeric coating composition may be applied using standard methods known in the art. For example, one conventional method of making latex gloves is to dip a former or mold in the shape of a hand into a coagulant mixture containing calcium nitrate. After drying, the mold is immersed in a latex emulsion for a time sufficient for the rubber to coagulate and form a coating of the desired thickness. Optionally, the glove then may be water leached to remove rubber impurities. The formed glove is then oven cured and cooled. After cooling, the glove is stripped from the mold and inverted. To coat the inside of the glove, the polymer coating composition may be applied immediately before or after latex curing.

The polymer coating may be used in an off-line coating process, as well as in on-line coating processes.

An adhesion promoter may be used, and for some polymers may be necessary, to add charge and increase the amount of polymer picked up. Such adhesion promoter is typically a water soluble salt such as sodium, calcium, zinc, or aluminum salts, particularly sodium chloride and calcium nitrate. The salt is typically provided in a concentration of up to about 40%, particularly from about 20 to about 40% by weight of coating suspension. The adhesion promoter is generally applied after leaching.

The latex article, i.e. glove, may be formed so that the polymer coating composition coats the inside surface of the article. The polymer coating composition provides the desired glove properties without the need for chlorination or other coatings, including powders. However, if only one surface is coated, chlorination or another coating may be used to provide the desired properties on the non-coated surface.

The polymer coating composition is sufficient to provide slip for easy donning, without the need for additional lubricant, such as surfactants and silicone compounds on top of the polymer coating.

The following examples are presented to further illustrate and explain the present invention and should not be taken as limiting in any regard.

### EXAMPLE 1

### Making a Polymer-Coated Rubber Glove

A ceramic mold was cleaned from contaminants, rinsed, heated to 40 to 50° C. and immersed for 15 to 20 seconds into the coagulant, a 20% aqueous solution of calcium nitrate. After dipping into the coagulant, the coagulant-coated mold was partially dried. The mold with coagulant was then immersed into a natural rubber latex at room temperature for the time required to build up a latex deposit with a required thickness. The latex deposit was then briefly dried in the oven. The mold coated with above deposit was then leached in water at about 65° C. to remove natural rubber proteins. The leached latex deposit was then dried and dipped into a polymer coating composition for up to one minute. After dipping with polymer dispersion, the latex deposit was vulcanized in the oven by heating at 90 to 130° C. for 15 to 30 minutes. After vulcanization, the coated rubber article was cooled and stripped from the mold. The ceramic mold was then cleaned.

### EXAMPLE 2

### Making a Polymer-Coated Rubber Glove

A ceramic mold was cleaned from contaminants, rinsed, heated to 40 to 50° C. and immersed for 15 to 20 seconds into the coagulant, a 20% aqueous solution of calcium nitrate. After dipping into the coagulant, the coagulant-coated mold was partially dried. The mold with coagulant was then immersed into a natural rubber latex at room temperature for the time required to build up a latex deposit with a required thickness. The latex deposit was then briefly dried in the oven. The mold coated with above deposit was then leached in water at about 65° C. to remove natural rubber proteins. The leached latex deposit was then vulcanized in the oven by heating at 90 to 130° C. for 15 to 30 minutes. After vulcanization, the coated rubber article was again leached in water, dried and dipped into a polymer coating composition dispersion for up to one minute. After drying the polymer lubrication layer, the glove was cooled and stripped from the mold. The ceramic mold was then cleaned.

### EXAMPLE 3

### Polymer Formulation

The polymer coating composition was prepared containing 2.5% by weight of NACRYLIC 6408 from NACAN Products Ltd. with 0.04% KELTROL RD xanthan gum, and 0.1% PMMA beads. The formulation was used for coating rubber articles, which exhibited good donning properties.

### EXAMPLE 4

### Polymer Formulation (Comparative)

The polymer coating composition was prepared containing 2.5% by weight of NACRYLIC 6408 only. The formulation showed some good donning, but the coating was non-uniform and had high flow.

### EXAMPLE 5

### Polymer Formulation (Comparative)

The polymer coating composition was prepared containing 1% by weight of PMMA beads only. The formulation showed some poor donning and non-uniform coating.

What is claimed is:

1. An article comprising a formed natural or synthetic rubber article having directly deposited thereon a continuous coating of an aqueous-based coating composition comprising:
a) 0.1 to 10 percent by weight of a high Tg polymer, having a Tg of from −10° C. to +120° C.; and
b) 0.01 to 1 percent by weight of microbeads, said microbeads having an oil adsorption of less than 150 g/10 g powder.

2. The article of claim 1 wherein said high Tg polymer has a Tg of from 25 to 110° C.

3. The article of claim 1, wherein said high Tg polymer comprises a (meth)acrylic emulsion polymer.

4. The article of claim 1, wherein said coating composition further comprising a rheology modifier.

5. The article of claim 1 having no lubricating layer on top of the polymer coating composition.

6. The article of claim 1, wherein the article is selected from the group consisting of gloves, prophylactics, catheters, balloons, tubing, and sheeting.

7. The article of claim 6, wherein the article is a glove selected from the group consisting of surgeons' gloves, physicians' examining gloves, and workers' gloves.

8. The article of claim 1, wherein the glove is powder-free.

9. A method of making a glove comprising:
a) dipping a former into a liquid comprising a coagulant, removing the former from the coagulant and drying it to form a layer of coagulant on the former;
b) dipping the former into rubber latex and drying it to form a partially-cured rubber deposit on the former;
c) dipping the deposit of rubber into a dispersion comprising microbeads, and a high Tg polymer, and drying it to form a continuous polymer coating on the rubber deposit;
d) vulcanizing the deposit of rubber with the polymer coating in an oven at about 100° C. until the rubber is vulcanized to the desired degree and the layers are bonded to the rubber; and
c) cooling and then removing a finished glove from the said former.

10. The method of claim 9(a) wherein said liquid comprising a coagulant further comprises a mold release agent.

11. The method of claim 9, further comprising after step (b) and before step (c), dipping the partially cured rubber deposit into water for sufficient time to remove at least some soluble proteins and other contaminants from the partially cured rubber deposit to form a leached partially cured rubber deposit.

12. The method of claim 9, further comprising dipping the leached partially cured rubber deposit into a solution comprising a salt to improve the adhesion of the second layer of polymer coating composition to the partially cured rubber deposit.

13. The method of claim 12, wherein the salt is sodium chloride.

14. A method of making a glove comprising:
a) dipping a former into a liquid comprising a coagulant, removing the former from the coagulant and drying it to form a layer of coagulant on the former;
b) dipping the former into rubber latex and drying it to form a partially-cured rubber deposit on the former;
c) vulcanizing the deposit of in an oven at about 100° C. until the rubber is vulcanized to the desired degree and the layers are bonded to the rubber;
d) dipping the deposit of rubber into a dispersion comprising microbeads, and a high Tg polymer, and drying it to form a continuous polymer coating on the rubber deposit; and
d) cooling and then removing a finished glove from the said former.

15. The method of claim 14(a), wherein said liquid comprising a coagulant further comprises a mold release agent.

16. The method of claim 14, further comprising after step (b) and before step (c), dipping the partially cured rubber deposit into water for sufficient time to remove at least some soluble proteins and other contaminants from the partially cured rubber deposit to form a leached partially cured rubber deposit.
